(19) United States
(12) Patent Application Publication
(10) Pub. No.: US 2005/0223783 A1
(43) Pub. Date: Oct. 13, 2005

(54) Microfluidic system

(75) Inventor: Alexander F. Spivak, Thousand Oaks, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: KAVLICO CORPORATION

(21) Appl. No.: 10/818,769

(22) Filed: Apr. 6, 2004

(51) Int. Cl. G01N 11/00; F04B 19/24

(52) U.S. Cl. 73/54.14; 417/52; 73/54.02

(57) ABSTRACT

A system for measuring viscosity includes microfluidic passageways coupled to a micro-cavity, and semiconductive electrodes for applying an electric field across said electrodes. The resultant pressure increase and deflection of the diaphragm changes the capacitance of the MEMS capacitor. Pumps such as a thermal pump or a surface acoustic wave pump control flow of fluid to be measured to and from the micro-cavity. Semiconductor device fabrication techniques are employed to produce the viscosity measurement system.

### FIELD OF THE INVENTION

This invention relates to the measurement of viscosity of polarizable dielectric fluids and related microfluidic systems.

### BACKGROUND OF THE INVENTION

For the determination of the contamination of a fluid, such the oil in an internal combustion engine, for example, it has previously been proposed to measure the dielectric constant of the oil. In the event of contamination by coolant, water, or gasoline, a measurable change in dielectric constant may be observed. However, the dielectric constant of oil also changes with usage; and in some cases, the dielectric constant measurement does not uniquely identify the source of the contamination.

### SUMMARY OF THE INVENTION

Accordingly, one object of the present invention is to provide additional information regarding the properties of the fluid, to identify the nature of any contamination of the fluid, for example.

Another object of the invention is to provide a viscosity measuring system which is of relatively small physical size, so that it may be readily used in applications where space is limited.

In accordance with one illustrative embodiment of the invention, a microfluidic viscosity measuring system includes a diaphragm, a cavity in proximity to the diaphragm, and electrodes for providing an electric field gradient in the cavity. In addition, microfluidic passageways are provided for directing polarized fluid to be tested to and from the cavity.

The polarizable fluid is drawn toward the high electric field gradient at the cavity, with the increased pressure at the cavity deflecting the diaphragm; and capacitive sensing arrangements measure the deflection of the diaphragm. With relatively low viscosity fluids, the pressure increase is rapid following application of voltage to the electrodes; whereas with higher viscosity fluids, the pressure increase is relatively slow following application of voltage to the electrodes. Accordingly, this varying response produces a corresponding variation in deflection of the diaphragm; and the resultant speed of change of the output capacitance from the diaphragm indicates the viscosity of the fluid.

In order to produce a viscosity sensor which is relatively small in size, it was determined that the viscosity sensor as described above may be fabricated using known semiconductor fabrication techniques. These techniques include the use of semiconductors, appropriately doped, etching, masking, ion implantation, and other known semiconductor techniques. In addition, of course, the ports are extremely small, with microfluidic channels being employed, and the necessary pumps being implemented by semiconductor fabrication techniques. Regarding size, the microfluidic channels may be several microns (10⁻⁶ meters) in size, and the entire assembly might typically be a few millimeters in extent.

Various features which may be included in the implementationof the microfluidic viscosity measurement system include:

1. Determining both the dielectric constant and the viscosity of fluid samples.

2. Using thermal pumps to change fluid samples.

3. Use of Peltier cells to control temperature.

4. Including semiconductor electronic circuitry on a single semiconductor substrate along with the micro-electromechanical constructions, such as the diaphragm and the pumps.

Other objects, features and advantages will become apparent from a consideration of the following detailed description and the accompanying drawings.

### BRIEF DESCRIPTION OF THE DRAWINGS

FIG. 1 is a schematic side view diagram of a viscosity measuring system illustrative of some aspects of the invention;

FIG. 2 is a plan view of one possible electrode configuration for the microfluidic unit of FIG. 1;

FIG. 3 is a more detailed schematic diagram of the physical components of a system illustrating the invention;

FIG. 4 is a diagram of a thermal micro-pump which may be employed to move fluid into and out of a central sensing cavity;

FIGS. 5A and 5B are schematic diagrams of one configuration of a multiple stage thermal pump;

FIG. 6A through 6D, 7A through 7D and 8A and 8B are diagrams indicating one set of semi-conductive fabrication techniques which may be employed in the formation of the microfluidic viscometer of the present invention;

FIG. 9 is a diagrammatic showing of pumping action provided by a surface acoustic wave structure;

FIG. 10 shows typical pressure variations for fluids of different viscosities following the application of voltages to the active electrodes adjacent to the microcavity;

FIG. 11 is a simplified diagrammatic showing of a central part of the system; and

FIG. 12 is a block diagram of a complete system illustrating the principles of the invention.

### DETAILED DESCRIPTION OF THE PREFERRED EMBODIMENTS

While the specification describes particular embodiments of the present invention, those of ordinary skill can devise variations of the present invention without departing from the inventive concept.

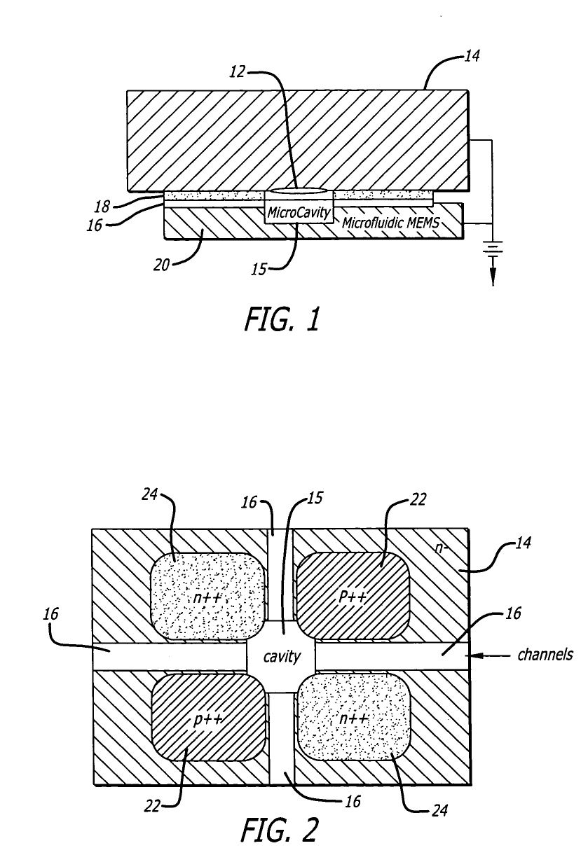

Referring more particularly to the drawings, FIG. 1 shows a semiconductor diaphragm 12 formed on a body of semi-conductive material 14. Underlying the diaphragm 12 is a microcavity 15 into which fluid is directed through the microfluidic channels 16. A thin layer of adhesive 18 bonds the upper body of semi-conductive material 14 to the lower body of semi-conductive material 20 into which the channels 16 are formed. Instead of adhesive material the semi-conductive bodies 14 and 20 may be fusion bonded, with one such method being described in U.S. Pat. No. 5,578,843.

FIG. 2 is a schematic cross-sectional view through semiconductive body 14 near the lower surface thereof, showing the electrode zones 24 where the silicon body is heavily doped with arsenic, phosphorous or antimony (periodic table column V-A elements) to form a n-type zone. Similarly, the silicon body 14 is heavily doped with boron, gallium or indium (Colum III-A elements) in areas 22 to fonn p-type electrode zones 22.

When a viscosity measurement is to be made, step voltages are applied to electrode zones 22 and 24. The resultant electric field gradient acts on the polarizable fluid in cavity 15 and channels 16 and exerts a force on the fluid toward the high electric field gradient zone in the cavity, thereby increasing the pressure in the cavity and deflecting the capacitive sensing diaphragm 12.

Fluids with low viscosity respond quickly to increase the pressure; while for high viscosity, or relatively thick fluids, the pressure increase is slower. By repetitively pulsing the voltages applied to electrode zones 22 and 24, and measuring the resultant changes in pressure measured by the variable capacitive sensing diaphragm 12, the viscosity of the fluid may be determined.

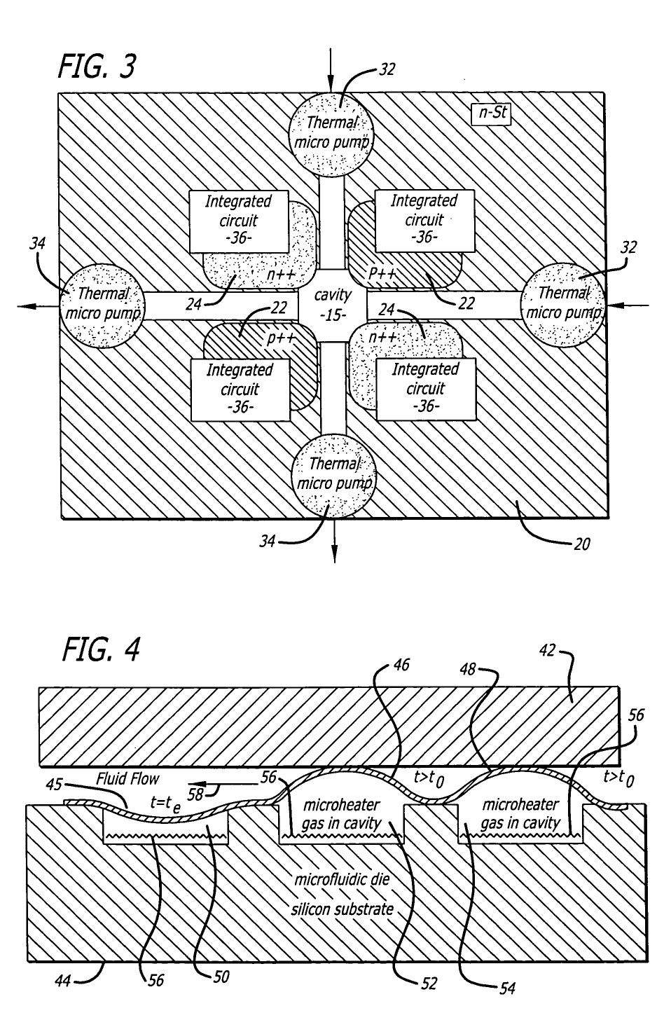

FIG. 3 is similar to FIG. 2 but also includes the pumps 32 and 34 which may for example, be thermal micro-pumps as described hereinbelow. Note that pumps 32 may be operated to being in new fluid for testing, and pumps 34 are shown operated to draw fluid out from the testing cavity 15. Note also the integrated circuits indicated by blocks 36. With the substrate 20 being formed of semi-conductor material such as silicon, circuitry including transistors, gates, etc., may be formed directly on the silicon base 20, or on the bottom of a trench in the silicon substrate.

FIG. 4 discloses one type of pump which may be employed in the implementation of the invention. The thermal micro-pump shown in FIG. 4 includes an upper semi-conductive die 42, a lower microfluidic substrate 44 and three diaphragms 45, 46 and 48. The diaphragms 45, 46 and 48 overlie gas-filled cavities 50, 52 and 54, respectively. Within each cavity is resistive material, preferably formed of the semi-conductive material as discussed below, and with these resistors being designated by the reference numeral 56. When a resistor 56 is energized and generates heat, the gas expands and the diaphragm deflects upward. Depending on the sequence of operation of the three stages, fluid in the micro-channel 58 flows in the desired direction. In FIG. 4, the diaphragm 45 is deflected downward indicating cool gas in chamber 50. The heaters 56 in cavities 52 and 54 are energized, and the gas expands, deflecting diaphragms 46 and 48 upward. With the diaphragm 48 initially deflected upward to substantially close the passage way 58 at the right hand end, subsequent upward deflection of diaphragm 46 will force fluid in the channel 58 past the downward deflected diaphragm 45, toward the cavity 15.

By reversing the sequence of operation of the three or more diaphragms, the fluid may be forced out of the unit, to the right as shown in FIG. 4. Now, referring back to FIG. 3, with pumps 32 bringing in new fluid, and pumps 34 pulling previously tested fluid out of the unit, a new sample of fluid for viscosity testing is brought into the test cavity 15.

Incidentally the gas in the cavities 50, 52 and 54 may be nitrogen, for example. The resistive elements may be in the form of free standing thin beams of doped silicon.

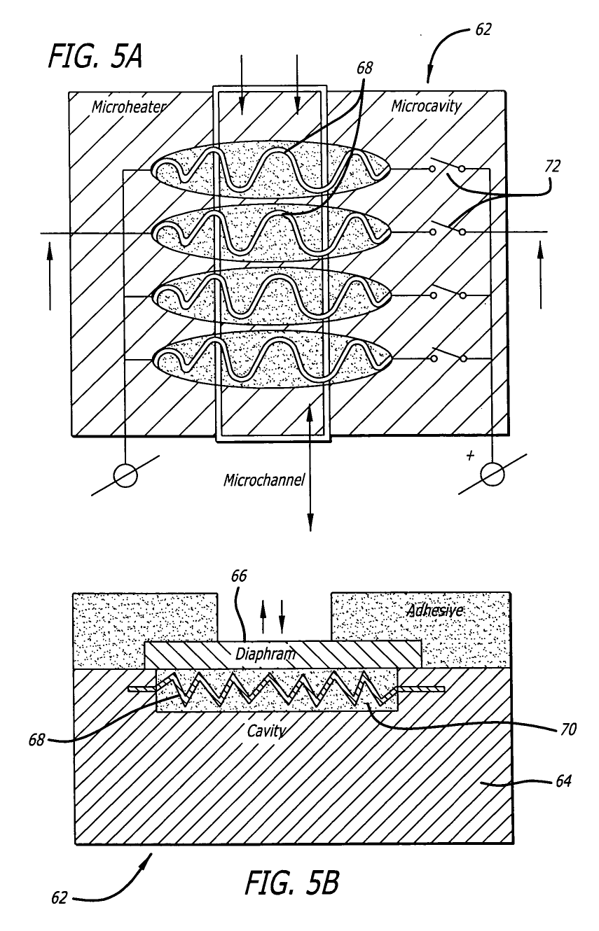

FIGS. 5A and 5B include two views of a four stage micropump 62, with the lower view of FIG. 5B being a diagrammatic cross-section view through one of the four pump units. In FIG. 5B, the substrate 64 has diaphragm 66 bonded thereto. The resistive element 68 is selectively energized to heat gas in cavity 70 and deflect the diaphragm 66. The switches 72 control the energization of the resistive elements 68, and these switches would in practice be in the form of semiconductor or programmed transistor switches.

The semiconductor type fabrication of the present microfluidic system will now be considered. Initially, reference is made to the following patents which disclose various fabrication methods such as surface and bulk micromachining. The methods are used in Micro-Electro Mechanical Systems approaches, often referenced by the acronym MEMS, with bonding and diaphragm constructions being disclosed, for examples.

U.S. Pat. No. 5,576,251 granted Nov. 19, 1996 entitled Process for Making a Semiconductor Sensor with a Fusion Bonded Flexible Structure;

U.S. Pat. No. 5,959,338 granted Sep. 28, 1999 entitled Micro Electro-Mechanical Systems Relay;

U.S. Pat. No. 6,136,212 granted Oct. 24, 2000 entitled Polymer-Based Micromachining for Microfluidic Devices;

U.S. Pat. No. 6,227,809 granted May 8, 2001 entitled Method for Making Micropumps;

U.S. Pat. No. 6,261,066 granted Jul. 17, 2001 entitled Micromembrane Pump;

U.S. Pat. No. 6,269,685 granted Aug. 7, 2001 entitled Viscosity Measuring Using Microcantilevers;

U.S. Pat. No. 6,311,549 granted Nov. 6, 2001 entitled Micromechanical Transient Sensor for Measuring Viscosity and Density of a Fluid;

U.S. Pat. No. 6,553,812 granted Apr. 29, 2003 entitled Combined Oil Quality and Viscosity Sensing System;

U.S. application Ser. No. 104,495 filed Mar. 22, 2002 entitled Fluid Property Sensors;

U.S. application Ser. No. 146,764 field May 15, 2002 entitled Method for Determining the Viscosity of an Operating Liquid of an Internal Combustion Engine; and

U.S. application Ser. No. 207,735 filed Jul. 26, 2002 entitled Microfluidic Viscometer.

Turning now to the method of making the microfluidic viscosity sensor, consideration will be given to the semiconductor fabrication techniques which may be employed. Initially the overall method steps will be identified, then specific method steps will be reviewed, and finally some step-by-step diagrams will be discussed.

Initially, therefore, the following broad steps will be listed in Table I, as follows:

1. Initial Material—silicon wafer.

2. Depression pattern formation: local oxidation and etching of grown oxide. Depression formation.

3. Wafer conductivity compensation: pWell formation on cavity bottom. pWell for integrated circuit or IC areas.

4. Field Oxide Deposition: Deposition of field oxide on cavity bottom.

5. Polysilicon Deposition and etching to form microheater beams and IC transistor gates.

6. Implantation by Boron: P++ area doping to form EHD-pump electrodes and pMOS.

7. Implantation by Arsenic to form n++ electrodes and nMOS areas.

8. Pump Diaphragm Formation by fusion bonding, thinning and etching.

9. Microfluidic channel etch.

10. Integrated Circuit (IC) formation; BPSG deposition; contact etching; metal deposition and etch.

11. Passivation layer deposition. Passivation layer above integrated circuits (IC).

12. Etch passivation layer to open contact windows and microchannels.

13. Adhesive bonding of capacitive sensor wafer to micropump wafer.

14. Wafer Dicing, Packaging, and lead wire bonding.

A general discussion of the fabrication steps will now be set forth. In the present specification the central cavity and associated diaphragm may be considered to be an electrohydrodynamic (EHD) pump, although the pump action merely deflects the diaphragm. Additional abbreviations which may be used from time to time include “MEMS” an acronym for Micro Electro Mechanical System, “LOCOS” for local oxidation, “IC” for Integrated Circuitry, “SAW” for Surface Acoustic Wave, “MOS” for Metal Oxide Semiconductor and “SOI” for Silicon on Insulation.

EHD-Pump and Thermopump Fabrication Process

Miniature pumps, hereafter referred to microfluidic Electro-hydrodynamic (EHD) pumps are constructed using fabrication techniques adapted from those applied to integrated circuits (IC) and MEMS devices. Such fabrication techniques are often referred to an micromachining. It is not intended that the present invention be limited by the particular micromachining technology for microfluidic channels and cavities formation. The EHD pump consists of a microcavity having a depth in the range of a few microns and microchannels connecting the microcavity and thermal pumps.

The first manufacturing step is mirofluidic device topology formation. Initially a flat surface silicon wafer is etched down by using different etching techniques to form the EHD-pump, thermal pump cavities, and a microchannel network. The microcavity and microchannels can be manufactured by one of the following methods—selective wet anisotropic etching, dry anisotropic etching, dry reactive ion etching (DRIE processes) or other known bulk micromachining techniques. In addition one can utilize a multiple LOCOS (local oxidation) and etching process that shapes a surface of a substrate to form a series of planar regions which are vertically separated from each other.

The second manufacturing stage is die surface implantation to form conductive areas with different types of conductivity. Conductive regions called electrodes can be formed by using standard ion implantation techniques. It is not intended that the present invention be limited by the particular shape of microchannels and implanted regions. The EHD pump channel walls are differently doped to form electrodes. Electrodes are utilized to initiate a pressure change inside of an etched EHD-pump microcavity,—thus, if a potential difference is applied between opposite sides of a microchannel, the induced electric field causes pressure distribution inside of a dielectric fluid. In order to have a homogenous potential distribution conformal to etched channel topology, the channel side walls are doped to form a well doped p++ region in one side of the channel and an n++ doped region on the opposite side of the channel. The spread sheet resistance of the doped area regions is preferably less than 50K Ohm/sqr. It is not intended that the present invention be limited by the particular wafer conductivity and impurity concentration used for channel side wall doping. However, the EHD pump channel side walls and the areas around the bottom are doped to have n++ and p++ doped areas. In addition the bottom of the microchannel is doped to compensate for Si wafer conductivity—this operation is done to increase the resistivity between n++ and p++ doped areas. For example if one uses an n-type silicon wafer, the compensating dopant may be boron (i.e., channel bottom should be implanted to make pWell). If one uses a p-type silicon wafer, the compensating dopant should be phosphorous, arsenic or antimony (i.e., channel bottom must be implanted to make nWell). The EHD pump channel bottom is counter doped so that the spread sheet resistance of the compensated regions is preferably greater than 50 kOhm/sqr. In addition a thin film of field oxide is preferably grown above the compensated regions. The grown oxide thickness is preferably more than one micron but less than microchannel depth, which is preferably in the range from two microns to ten microns. One illustrative channel topology and dopant distribution in an EHD-pump are shown in the drawings and described below. It is not intended that the present invention be limited by the particular die topology, number of microchannels, microchannel shape, and cavity location shown in the drawings. The cavity shape and dimensions as well as microchannel shape and dimensions can be different for different EHD-pump designs.

In addition the implantation process can include electrode formation and etch stop implantation for thermal-pump heaters bulk micromachining. The thermal-pump heater may be implemented by a free standing conductive beam (conductive material strip) elevated above the bottoms of a microcavity when the heater is attached to the walls of the thermal-pump cavity. The beam is utilized as a heater when electric current flows through it. It may have different shapes and dimensions. In addition, an implantation process can be used to form Peltier cells placed on the microfluidic die surface for die temperature adjustment. The Peltier effect is the converse of the Seeback effect. These phenomenon involve the passage of an electrical current through a junction consisting of two dissimilar doped areas (p/n-junction) resulting in a cooling effect; and when the direction of current flow is reversed, heating will occur.

The manufacturing of thermal-pump heaters is the third device manufacturing stage. The heating elements, such as beams, can be formed either by using a polysilicon layer or by bulk etching in a single crystal silicon wafer. A polysilicon layer is deposited on a sacrificial layer that is subsequently removed to provide gaps or cavities between the polysilicon layer and the cavity bottom. A single crystal beam can be formed by using bulk micomachining methods such as selective wet anisotropic etching, or dry anisotropic etching, or other known bulk micromachining methods.

The next stage is thermal-pump diaphragm formation. The thermal-pump diaphragm covers each of the pump cavities to form a sealed volume inside the thermal pump cavity. The diaphragm can be formed either by using conventional surface micromachining technique based on polysilicon deposition or by a fusion bonding method. A recently developed form of surface micro-machining employs a monocrystalline layer that is fusion bonded to a structured substrate. In both cases standard semiconductor fabrication processing techniques are needed for diaphragm shape formation.

An example of a viscosity sensor fabrication process is shown in the drawings and discussed below.

Example of Viscosity Sensor Fabrication Process

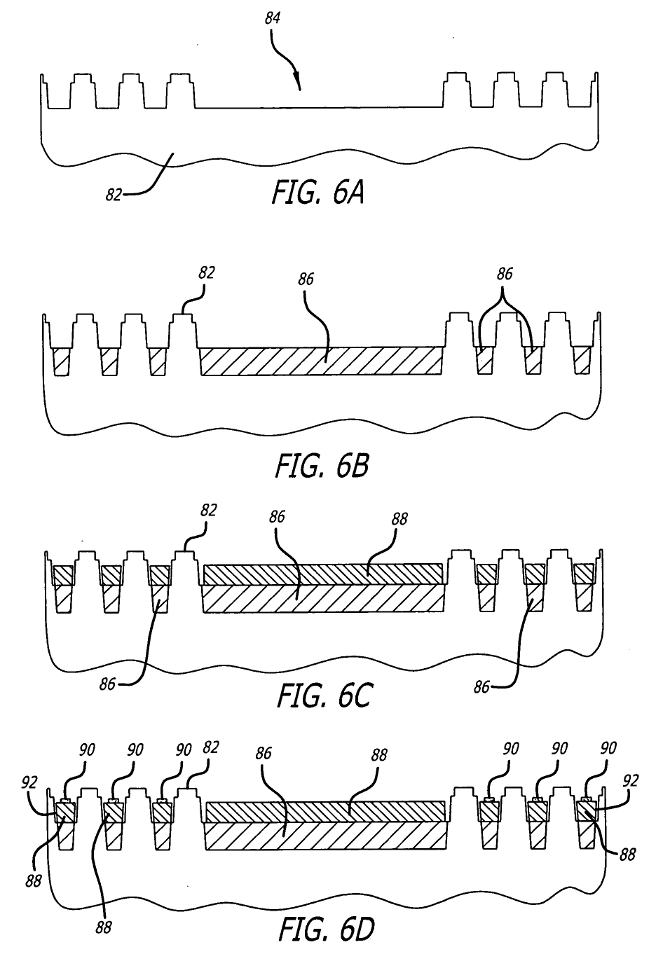

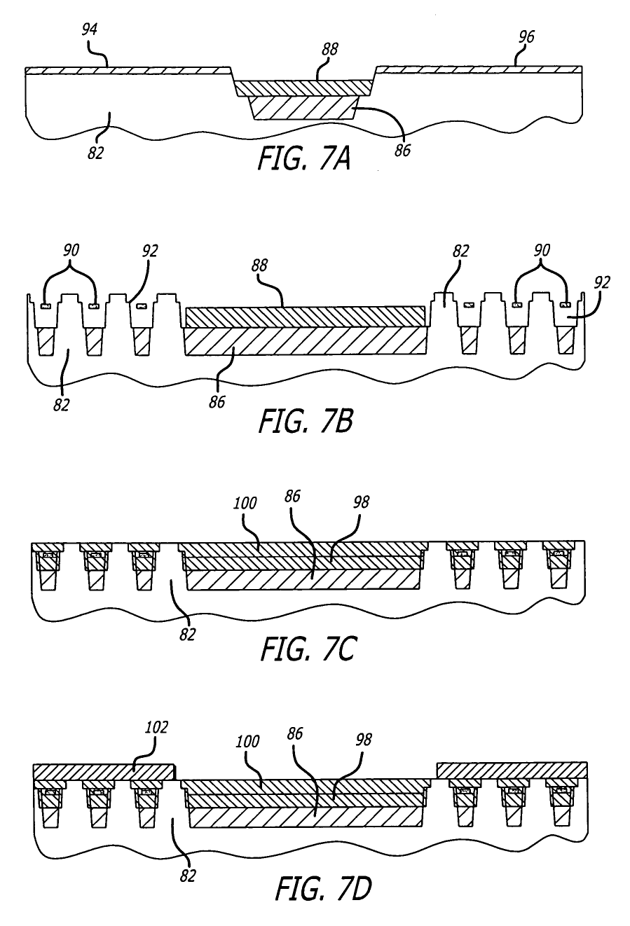

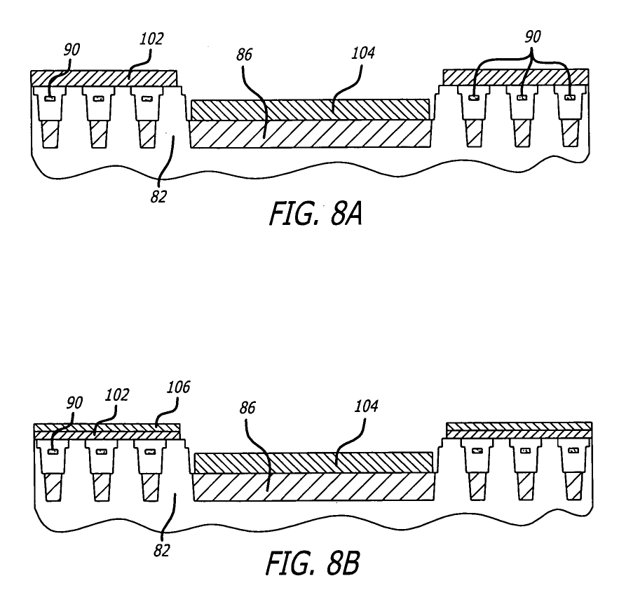

We will now consider an illustrative example of viscosity sensor fabrication process. The process sequence is set forth in Table I set forth hereinabove. The microfluidic die manufacturing stages are started with a one side polished wafer of n-Si (n-type silicon), The wafer surface used for manufacturing should be well polished with RMS roughness less than 4 angstroms. Wafer toplogy/depressed channel areas are formed by using local oxidation and oxide etching process as it is described for example, in U.S. Pat. No. 5,966,617. Local oxidation (LOCOS) of Silicon is the most widely used method for creating isolations in nMOS and pMOS transistors. In the LOCOS approach, the oxide is selectively grown over the field regions of the integrated circuit. Topology formation process includes (1) oxidizing the substrate to form an oxide regions; (2) removing the oxide region to form the depression and forming an active region in semiconductor substrate. A typical LOCOS step includes forming a thin pad oxide layer; depositing a silicon nitride layer on the pad oxide layer; forming a composite mask overlying and covering the unetched regions; etching away the exposed parts of the silicon nitride layer to expose regions of silicon for oxidation; and oxidizing the exposed regions in a wet oxygen atmosphere at about 1050° C. to form silicon dioxide regions that are about 3 μm thick. The silicon nitride that protects region from oxidation during the LOCOS step is stripped away using a standard process such as plasma etching or the application of hot phosphoric acid before or after removal of oxide regions and the pad oxide layer. Standard techniques such as wet etching remove the oxide regions and leave the silicon substrate. The resultant bulk silicon wafer 82 with the depressed regions 84 is shown in FIG. 6A.

In order to prevent leakage and electric field shorting by the channel bottom the channel bottoms are doped with boron to make boron doped areas called pWells.

In FIG. 6-B the pWell areas 86 are shown to advantage. In addition the pWell doped areas 86 are oxidized by LOCOS. Cavity bottom oxidation is done to isolate the channel bottom and prevent electric field short circuiting. The field oxide layer 88 grown by LOCOS is shown in FIG. 6-C.

The thermal pump element preferably employs free standing beams 90 used as thermal pump heaters. The beams 90 are located inside thermal pump microcavities 92 as shown in FIG. 6-D. If electric current is applied through a free standing resistive beam, the temperature inside of the cavity significantly increases. As a result trapped gas in the cavity gas expands and pushes up the diaphragm covering the pump cavity. In the present example each beam 90 is made of poly silicon deposited and etched inside of a thermal pump cavity. The deposited poly silicon layer is a part of standard CMOS procedures used for integrated circuit (IC) formation. It is also used to form transistor gates, poly resistors, and analog capacitor electrodes.

The next fabrication step is EHD-pump electrode formation. The electrodes are conductive regions doped either by boron(p++ region) or by arsenic(n++ region) implanted around the microcavity. A diagrammatic showing of implanted electrode areas is set forth in FIG. 7-A, in which 82 is the bulk silicon wafer, 94 is the n++ electrode area and 96 is the p++ electrode area.

In order to make each thermal pump heater, which is just a free standing beam/strip, each polysilicon strip 90 is released from silicon dioxide layer (see FIG. 6-D). The release process can be effected, for example, by etching with a hydro fluoric solution. For example, silicon dioxide located inside of thermal pump cavity can be etched out by a dilute (10:1) hydrofluoric aqueous solution. FIG. 7-B shows the die structure after releasing the polysilicon beams (thermal pump heaters) 90, located within the microcavities 92.

The thermal pump cavities are covered by flexible membranes 102 that can be formed by utilizing a fusion bonding approach. In such a case the first (microfluidic device) substrate is bonded to SOI wafer so that the depression overlies the active region. SOI is an acronym for Silicon On Insulator. The SOI wafer included a buried electrical insulating layer just below the surface. This layer is conventionally silicon dioxide. Such wafers can make a convenient starting point for some types of Micro-Electro Mechanical Systems (MEMS). After bonding, the SOI wafer is thinned by utilizing grinding and etching techniques. The membrane covering the depressed regions may be formed by using TMAH (Tetramethylammonium hydroxide, an anisotropic wet etchant) etc. Details of fusion bonding and diaphragm/membrane formation processes are described in U.S. Pat. No. 5,578,843; U.S. Pat. No. 5,576,251 and U.S. Pat. No. 6,008,113.

An alternative approach of diaphragm/membrane formation as shown in FIGS. 7-C and 7-D is based on the following steps: (1) polysilicon 98 is formed above silicon dioxide layer 86 which was previously deposited in the depressed regions; (2) the polysilicon layer 98 is etched out to form a pattern; (3) the wafer surface is then covered by sacrificial layer 100 of silicon dioxide deposited by LPCVD method; (4) the deposited oxide film 100 is planarized by using a CMP/Chemical Mechanical Polishing technique (CMP means using a compound to polish a wafer's surface to eliminate topological layer effects in the manufacturing of semiconductors and MEMS); (5) an additional poly-silicon film is deposited above the polished sacrificial oxide; and (6) the polysilicon layer is etched out either by using RIE/Reactive Ion Etch or by wet TMAH-etch to form a flexible membrane covering the depressed regions. In order form free standing resistive beams made of polysilicon, the sacrificial layer must be removed as discussed above relative to FIG. 7-B. One showing of this alternative membrane formation process is set forth in the FIG. 7-C. The flexible membrane formation stage is accomplished after the standard MOS process that forms the require active regions of the integrated circuitry, see FIG. 7-D. In addition, in FIG. 7-D, the reference numeral 102 refers to the diaphragm/membrane.

With reference to FIG. 8-A, reference numeral 82 refers to the bulk silicon, 86 is the pwell doped area, 104 is the layer of field oxide, 102 is the membrane or diaphragm, and 90 refers to the resistive beams, following etching out of the underlying sacrificial oxide layer. The die manufacturing step is completed following etching of the microchannels 106 on the diaphragm surface, as shown in FIG. 8-B.

The last wafer manufacturing stage involves the adhesive bonding of microfluidic die and a MEMS pressure sensor as indicated broadly in FIG. 1 of the drawings. The manufacturing process and design of the MEMS pressure sensor is described in U.S. Pat. No. 6,495,388; U.S. Pat. No. 6,008,113; U.S. Pat. No. 5,578,843 and U.S. Pat. No. 5,966,617. After adhesive bonding of the pressure sensor, the wafer is diced and each die is packaged and tested separately.

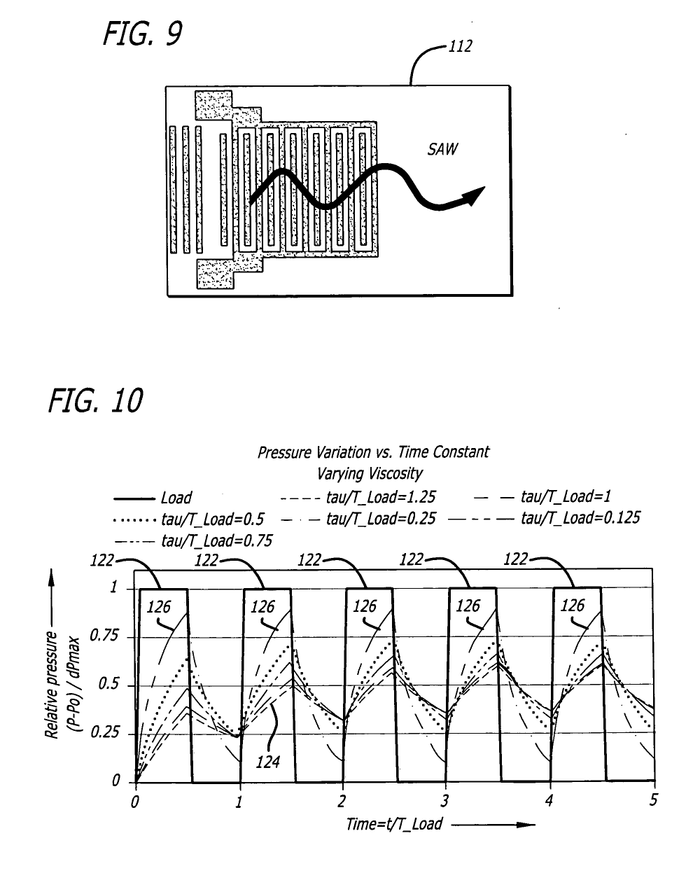

Referring now to FIG. 9 of the drawings, a surface acoustic wave source 112 is shown as an alternative to the thermal pumps disclosed above. When energized, the surface acoustic wave propagates along the wave guide and the vibrating surface drags adjacent fluid along in the direction of wave propagation.

FIG. 10 is a diagrammatic showing of pressure plotted against time, and for fluid samples of varying viscosity. In operation, a series of pulses, such as square wave voltage pulses are applied between the electrodes 22 and 24 adjacent the microcavity. As a result, bulk forces 122 are induced in the channels and cavity. Plots of the response for a series of fluids of different viscosity are shown, with the higher viscosities having a sluggish response, see reference numeral 124, for example; and low viscosity fluids having a rapid response, resulting in high diaphragm deflections, as indicated by the plot 126, for example. The voltage output pulses derived from diaphragm capacitance changes, are integrated, and the low viscosity polarizable fluids have the highest output level, while the higher viscosity fluids have relatively low integrated voltage outputs.

In FIG. 10, the voltage applied to the electrodes relates to the plot 122, designated the “load” plot. The other plots represent the output response for samples of different viscosities.

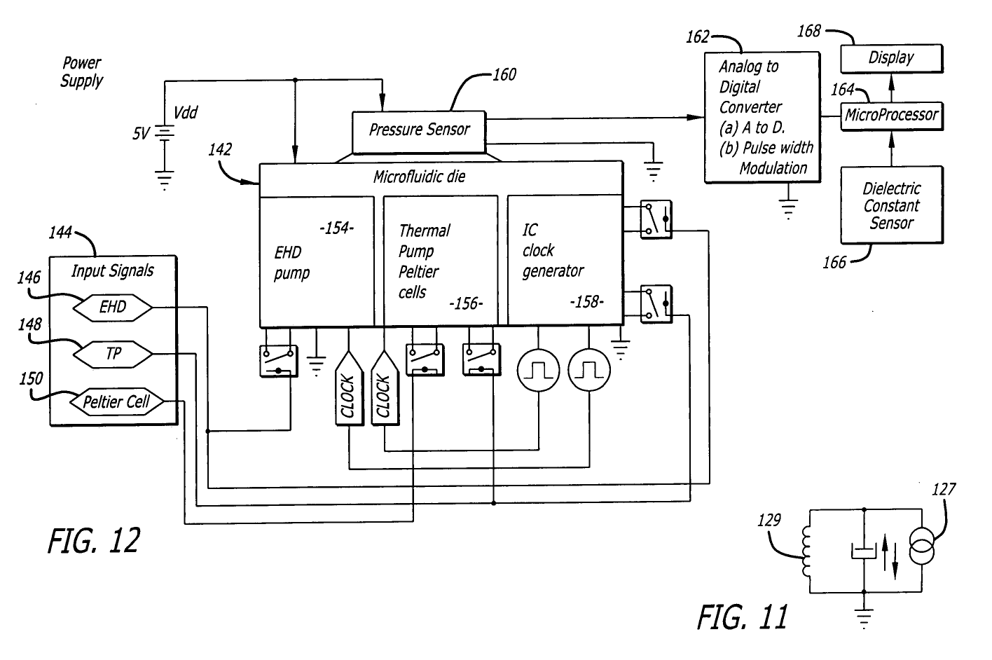

FIG. 11 is a simplified diagrammatic showing of a central part of the system described in greater detail hereinabove. More specifically, in FIG. 11, reference numeral 127 refers to a pressure generating micropump, reference numeral 129, showing a coil, indicates the elastic deformation of the central diaphragm, and the dashpot 131 represents the viscous damping of the viscous fluid being measured. The micropump 127 is preferably the EHD pump shown for example in FIG. 2, but could be the micropumps such as the surface acoustic wave pump of FIG. 9, or the thermal pumps of FIGS. 4 and 5.

FIG. 12 is a circuit diagram of an illustrative embodiment of the viscosity measurement system. In FIG. 12 the microfluidic die 142 includes the microcavity and the thermal pumps as described hereinabove. The input signals from circuitry 144 include the EHD square wave pump signals 122 (see FIG. 10), indicated at 146 in FIG. 12, the thermal pump input signals 148, and the Peltier cell input 150. Regarding the thermal pump signals, with three thermal pumps in series, the sequence of energization determines the pump fluid flow direction. Regarding the Peltier cell energization, this may be energized to maintain a predetermined temperature. Alternatively, the temperature may be sensed and the sensed output from the micro-cavity diaphragm appropriately corrected.

Within the microfluidic die 142 are the microcavity and associated EHD pump 154, the thermal pumps and Peltier cells indicated by block 156; and the integrated circuitry including the clock generator are indicated at block 158.

The pressure sensor 160 may be that as described in U.S. Pat. No. 5,578,843 cited hereinabove. Signals from pressure sensor 160 are supplied to the Analog to Digital converter, which converts analog signals (either voltage level or pulse width modulated) to digital form. The microfluidic die 142 may include an integrator and other signal processing circuitry. Signals from the A/D converter 162 are applied to microprocessor 164. A complete system may also include input from a dielectric constant sensor 166, to the microprocessor 164. An output display 168 from the microprocessor 164 may also be provided.

While the specification describes particular embodiments of the present invention, those of ordinary skill can devise variations of the present invention without departing from the spirit and scope of the invention. Thus, by way of example and not of limitation, other types of pumps may be employed instead of the thermal pumps or the surface acoustic wave pump described above. Also different types of semi-conductive material and different micro-machining steps may be employed. Other electrode configurations may be employed to establish high electric field gradients at the microcavity. Accordingly, the present invention is not limited to the specific system as described in detail hereinabove.

1. A microfluidic viscosity measuring system comprising:
a semiconductor diaphragm;
microfluidic passageways for directing polarizable dielectric fluid to a cavity in proximity to said diaphragm;
semiconductor electrodes for providing an electric field gradient adjacent the diaphragm;
capacitive sensing arrangements for providing a variable output capacitance with deflection of the diaphragm;
circuitry for varying the voltage applied to said electrodes, causing resultant deflection of said diaphragm; and
circuitry coupled to said capacitive sensing arrangements for measuring the changes in pressure resulting from voltage variations applied to the electrodes, thereby determining the viscosity of the fluid.

2. A viscosity measuring system as defined in claim 1 further comprising microfluidic pumps for supplying said polarizable fluid to said cavity.

3. A viscosity measuring system as defined in claim 1 wherein said electrodes are formed of oppositely doped semiconductive material.

4. A viscosity system as defined in claim 1 wherein said diaphragm is less than 800 microns in diameter.

5. A viscosity measuring system as defined in claim 1 wherein said diaphragm is formed of semiconductive material.

6. A microfluidic viscosity measuring system as defined in claim 1 wherein said microfluidic passageways are less than ten microns in cross-section.

7. A microfluidic viscosity measuring system as defined in claim 1 including circuitry for applying electric pulses to said electrodes.

8. A microfluidic viscosity measuring system as defined in claim 1 wherein said microfluidic pumps are thermal pumps each including a diaphragm and an associated cavity having gas therein, with resistive material for heating the gas and deflecting the diaphragm.

9. A system as defined in claim 8 wherein said resistive material is a semiconductive beam within said cavity.

10. A microfluidic viscosity measuring system as defined in claim 1 wherein said electrodes include at least one highly p-type doped area, and at least one highly n-type doped area.

11. A microfludic viscosity measuring system as defined in claim 9 wherein two p-typed doped areas are alternated with two n-type doped areas adjacent the diaphragm.

12. A microfluidic viscosity measuring system as defined in claim 1 wherein the bottom of said cavity has spaced semiconductive electrodes thereon.

13. A microfluidic viscosity measuring system as defined in claim 1 wherein said diaphragm is fusion bonded to said cavity.

14. A microfluidic viscosity measuring system as defined in claim 1 wherein said diaphragm is adhesively bonded to said cavity.

15. A microfluidic viscosity measuring system comprising:
a diaphragm;
microfluidic passageways for directing fluid to a cavity in proximity to said diaphragm;
semiconductor electrodes for providing an electric field gradient in the cavity;
capacitive sensing arrangements for providing a variable output capacitance with deflection of the diaphragm;
circuitry for applying voltage to said electrodes, causing increased pressure in said cavity and resultant deflection of said diaphragm; and
circuitry coupled to said capacitive sensing arrangements for measuring the changes in pressure resulting from voltage applied to the electrodes, thereby providing an indication of the viscosity of the fluid.

16. A microfluidic viscosity measuring system as defined in claim 14 further comprising microfluidic pumps for supplying said polarizable fluid to said cavity.

17. A microfluidic viscosity measuring system as defined in claim 14 wherein said electrodes are formed of oppositely doped semiconductive material.

18. A microfluidic viscosity system as defined in claim 14 wherein said diaphragm is less than 800 microns in diameter.

19. A microfluidic viscosity measuring system as defined in claim 14 wherein said microfluidic passageways are less than ten microns in cross-section.

20. A microfluidic viscosity measuring system comprising:
a semiconductor diaphragm;
microfluidic passageways having a cross-sectional dimension less than 10 microns, for directing polarizable dielectric fluid to a cavity in proximity to said diaphragm;
electrodes for providing an electric field gradient adjacent the diaphragm;
capacitive sensing arrangements for providing a variable output capacitance with deflection of the diaphragm;
circuitry for applying voltage to said electrodes, causing resultant deflection of said diaphragm; and
circuitry coupled to said capacitive sensing arrangements for measuring the changes in pressure resulting from voltage applied to the electrodes, thereby providing an indication of the viscosity of the fluid.

21. A microfluidic viscosity measuring system as defined in claim 20 wherein said microfluidic pumps are thermal pumps each including a diaphragm and a cavity having gas therein, with resistive material for heating the gas and deflecting the diaphragm.

22. A microfluidic measuring system comprising:
a semiconductor diaphragm;
microfluidic passageways for directing fluid to a cavity in proximity to said diaphragm;
microfluidic pump means for increasing the pressure of said fluid in said cavity causing resultant deflection of said diaphragm; and
circuitry coupled to said capacitive sensing arrangements for measuring the changes in pressure in said cavity.

23. A system as defined in claim 22 wherein said pump means is an electrohydrodynamic pump.

24. A system as defined in claim 22 wherein said pump means includes at least one thermal pump having a diaphragm, an associated cavity having gas therein and resistive material for heating the gas and deflecting the diaphragm.

25. A system as defined in claim 22 wherein said resistive material is a semiconductive beam within said cavity.

26. A microfluidic system comprising:
microfluidic passageways for directing the flow of liquid;
a thermal pump for moving liquid through said passageways;
said pump including a diaphragm, an associated cavity containing gas, and a resistive semiconductive beam in said cavity for heating the gas, thereby deflecting the diaphragm and displacing the fluid.

27. A system as defined in claim 26 wherein said resistive beam is spaced from the walls of said cavity.
